(19) United States
(12) Patent Application Publication
(10) Pub. No.: US 2009/0225800 A1
(43) Pub. Date: Sep. 10, 2009

(54) VERY LOW-NOISE SEMICONDUCTOR LASER

(76) Inventors: Mehdi Alouini, Saint-Martin-De-Brethencourt (FR); Ghaya Baili, Bures Sur Yvette (FR); Chantal Moronvalle, Chevilly Larue (FR); Fabien Bretenaker, Velizy (FR); Daniel Dolfi, Orsay (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/917,148

(22) PCT Filed: Jun. 7, 2006
(86) PCT No.: PCT/EP2006/062975

§ 371 Date: Dec. 10, 2007

(30) Foreign Application Priority Data
Jun. 10, 2005 (FR) 0505937

(51) Int. Cl. H01S 3/13; H01S 3/08

(52) U.S. Cl. 372/29.011; 372/102; 372/98; 372/99

(57) ABSTRACT

The subject of the invention is a laser comprising a semiconductor active medium with a population inversion lifetime τ_{c} and a resonant cavity with a lifetime of the photons in the cavity τₚ. The cavity includes means for being longitudinally monomode and means so that τₚ>τ_{c}, such as for example a very long cavity, so as to obtain a laser with a very low intrinsic noise.

### CROSS-REFERENCE TO RELATED APPLICATIONS

The present Application is based on International Application No. PCT/EP2006/062975, filed Jun. 7, 2006, which in turn corresponds to French Application No. 05 05937, filed on Jun. 10, 2005, and priority is hereby claimed under 35 USC §119 based on these applications. Each of these applications are hereby incorporated by reference in their entirety into the present application.

### FIELD OF THE INVENTION

The field of the invention is that of lasers with a large dynamic range, used in particular in telecommunication systems with digital signals, in radar systems with analog signals, etc.

### BACKGROUND OF THE INVENTION

The increase in dynamic range of a laser is achieved by increasing its power and/or by reducing its intrinsic intensity noise.

In what follows, very low-noise lasers will be considered. These lasers are also used in novel applications, such as for the optical manipulation of atoms, or atomic and molecular spectroscopy, for quantum memories, for quantum cryptography, for large interferometers, for detecting gravitational waves, etc.

The technique most widely used for producing a very low-noise laser consists in placing, at the output of the laser, an electrooptic device called a “noise eater”.

It is also possible to use longitudinally pumped solid-state lasers such as Nd:YAG or Er:Yb/glass lasers.

In both these cases, the reduction in intensity noise of the laser is obtained over small spectral ranges, typically 1 MHz, because of the use of an electrical feedback control loop.

### SUMMARY OF THE INVENTION

One important object of the invention is therefore to produce a very low-noise laser over spectral bands greater than 20 GHz.

To achieve this object, the invention provides a laser comprising a semiconductor active medium with a population inversion lifetime τ_{c} and a resonant cavity with a lifetime of the photons in the cavity τp, mainly characterized in that the cavity includes means for being longitudinally monomode and means so that τₚ>τ_{c}.

Such a laser therefore has almost a white noise spectrum over a potentially infinite frequency band, the ideal condition for transmission of broadband analog signals for example.

Preferably, when the cavity is capable of producing several modes, the means for obtaining a monomode cavity include means for filtering these modes.

According to one feature of the invention, when the semiconductor has a length l, the cavity is external and has a length L>100 l so as to obtain τₚ>τ_{c}.

The means for filtering these modes comprise for example a Bragg grating and/or a Fabry-Perot interferometer; the cavity optionally includes an isolator and/or an optical fiber.

According to another feature of the invention, when the cavity is external and includes filtering means and at least one mirror external to the semiconductor, the filtering means comprise this external mirror and this mirror is photorefractive.

According to another feature of the invention, the external cavity includes an external output mirror, and the latter is a concave mirror or a plane mirror associated with a collimating lens or comprises at least one photorefractive crystal.

According to one embodiment, the cavity includes mirrors having a reflection coefficient R>80%.

The laser may be monolithic and have two faces having a reflection coefficient R>80%.

According to one feature of the invention, the semiconductor is a semi-VCSEL or quantum dot semiconductor or a quantum cascade semiconductor.

According to another feature of the invention, the semiconductor is a quantum cascade semiconductor and the cavity is external and includes a waveguide external to the semiconductor.

The laser may furthermore include a feedback control device.

### BRIEF DESCRIPTION OF THE DRAWINGS

Other features and advantages of the invention will become apparent on reading the following detailed description given by way of nonlimiting example and with reference to the appended drawings in which:

FIG. 1 shows schematically an example of a laser according to the invention, the external cavity of which is a ring cavity;

FIG. 2 shows schematic curves of the transmission T of the signal as a function of the wavelength λ in the presence of spectral filtering obtained by the insertion of a Bragg grating and of a Fabry-Perot interferometer into the cavity; and

FIG. 3 shows schematically various examples of linear-cavity lasers according to the invention: having an external cavity with a concave mirror (3a); having a plane mirror and a collimating lens (3b); having a photorefractive crystal and a collimating lens (3c); having a mirror and a waveguide (3d); and a monolithic laser without an external cavity (3e).

Ongoing from one figure to another, the same elements are indicated by the same references.

### DETAILED DESCRIPTION OF THE DRAWINGS

The origin of the intrinsic noise of a laser will firstly be analyzed.

Most lasers used at the present time, such as standard semiconductor lasers, doped-glass or doped-crystal solid-state lasers, doped-fiber lasers, etc., are called “Class B” lasers. The main characteristics of a Class B laser is that the lifetime of the photons τₚ in the laser cavity is shorter than the population inversion lifetime τ_{c}. To give an example, in a semiconductor laser, τ_{c} is of the order of 1 ns while τₚ is around 10 ps. In a doped-crystal or doped-glass laser, the population inversion lifetime τ_{c} is even longer, typically 100 μs to 10 ms.

Since the photon lifetime is shorter than the population inversion lifetime, these lasers undergo relaxation oscillations at the frequency υᵣ, the value of which is proportional to the pumping rate η of the laser and to the inverse of the lifetimes τₚ and τ_{c}:

$${v}_{r} \approx \frac{1}{2 π} \sqrt{( η - 1 ) \frac{1}{{τ}_{p} {τ}_{c}}}$$

These relaxation oscillations are the reason for the presence of excessive noise, the maximum of which is at υᵣ. In a conventional semiconductor laser, the resonant frequency υᵣ is located at about 10 GHz. This frequency therefore lies right in the middle of the useful frequency band for analog signal transmission systems. Conversely, diode-pumped solid-state lasers have a very low noise in the 100 MHz-20 GHz band. However, they exhibit resonance, which lies between 100 kHz and 1 MHz depending on the active medium used. The excess noise is also a problem at these frequencies for a good number of applications, but also for analog signal transmission systems since this noise appears at the bottom of the carrier wave.

Now, the resonant frequency υᵣ disappears when the lifetime of the photons in the laser cavity becomes longer than the characteristic recombination time of the carriers, a characteristic property of what are called “Class A” lasers. Such a laser then has an almost white noise spectrum over a potentially infinite frequency band, the ideal condition for broadband analog signal transmission for example.

The principle of the invention consists in acting on the dynamics of interaction between the photons and the amplifying medium of the laser so as to be in a particular operating regime that allows the lifetime of the photons in the laser cavity to be appreciably extended compared with the population inversion lifetime in the amplifying medium or the lifetime of the carriers in the case of a semiconductor laser.

According to this principle, what is obtained from a standard Class B laser, such as a semiconductor laser, is an operating regime equivalent to that of Class A lasers by significantly increasing the lifetime of the photons in the laser cavity and/or by reducing the population inversion lifetime in the amplifying medium. The laser source must remain longitudinally monomode so as to avoid intermodal beat noise.

According to a first embodiment based on increasing the lifetime of the photons in the laser cavity, and described in relation to FIG. 1, the laser 1 according to the invention has, as active medium 2, a semiconductor length l and an external cavity of length L>100 l.

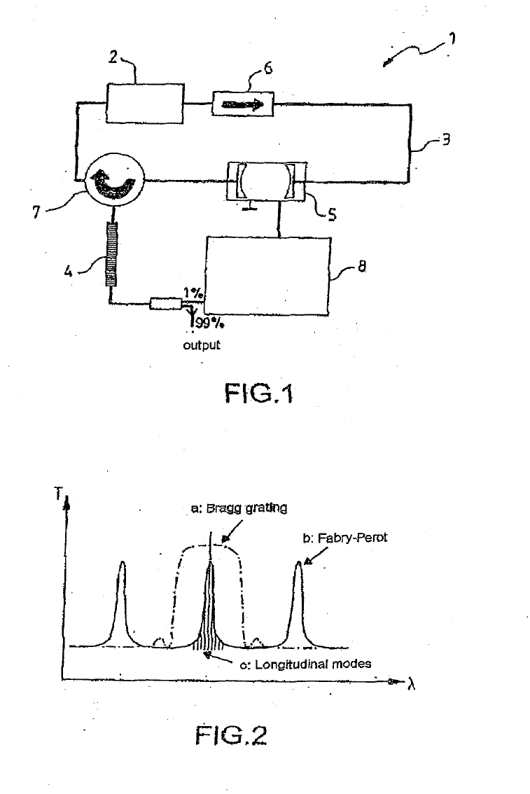

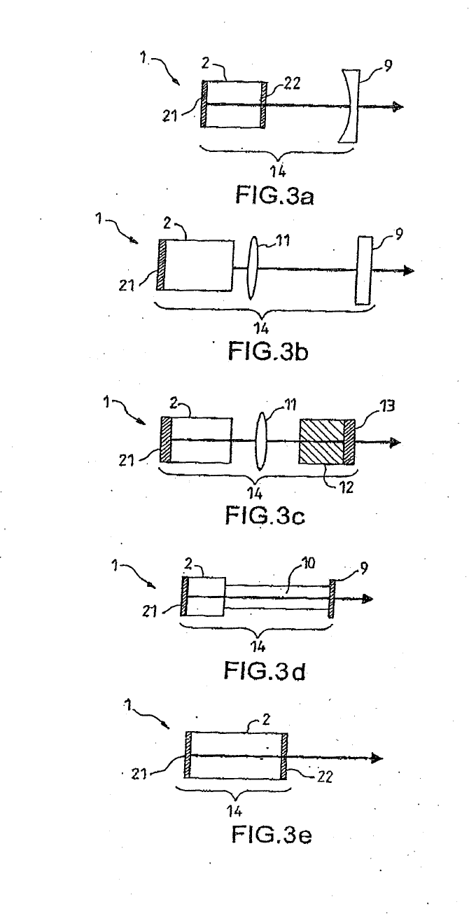

In the example shown in the figure, the starting cavity, which is that of the semiconductor, is extended by means of an optical fiber 3 which is looped back to the semiconductor. The ring cavity thus formed has a length L of a few meters, for example 5 m. Such a cavity length corresponds to a free spectral interval of a few tens of MHz, thereby permitting simultaneous oscillation of several thousand longitudinal modes (40 nm gain spectral width). There is therefore spectral filtering of these longitudinal modes, illustrated by curve c in FIG. 2. In a first step, the insertion of a Bragg grating 4 into the cavity makes it possible to reduce the oscillation range to 0.05 nm—curve a illustrates this filtering. By adding a Fabry-Perot interferometer 5 in the cavity, so as to be in series with the Bragg grating, it is possible to select a single longitudinal mode within the 0.05 nm band—curve b illustrates this filtering. In order for the filtering to be optimal, an isolator 6 is also placed in the cavity, making it possible to impose a direction of rotation on the laser mode. In this way, spatial hole-burning effects that promote multimode oscillation are obviated. Moreover, by fixing the rotation direction of the light, the light is made to pass through the Fabry-Perot and, consequently, it is spectrally filtered. This is because, when the isolator is not present, the laser can oscillate in the linear cavity between the two input mirrors of the Fabry-Perot.

Thus, starting from the semiconductor, the light passes, in order, through the isolator and then the Fabry-Perot. Next, a circulator 7 directs the light onto the Bragg grating, which acts as output coupler and spectral filter. The light reflected by the Bragg grating is finally directed back into the semiconductor 2.

In order for the frequency of the Fabry-Perot transmission maximum and the frequency of the longitudinal mode selected to remain coincident, the resonant frequency of the Fabry-Perot is locked onto this longitudinal mode. This can be achieved using a feedback control device 8, such as a synchronous detection device. Such feedback control also makes it possible to compensate for any mode drift caused by a change in temperature or by mechanical stress variations.

Such a laser oscillates at 1549 nm and remains longitudinally monomode. In particular, the modulation response of the laser shows that the resonance has disappeared and that it behaves as a Class A laser, i.e. such that τₚ>τ_{c}.

The results obtained on the noise measurements confirm that the laser obtained is a very low-noise laser—the noise spectrum of this laser is very much below that of a standard DFB laser. This is because the RIN (Relative Intensity Noise) of the laser is limited by the shot noise over the entire spectral range accessible experimentally by the measurement equipment (100 MHz-21 GHz). Since the output power of the laser under the experimental conditions is 1.8 mW, its relative shot noise is at—156 dB/Hz.

According to another embodiment, again based on increasing the lifetime of the photons in the laser cavity, a linear external cavity a few centimeters in length but of high-Q is used. This is because in a high-Q cavity the photons perform several hundred round trips before leaving the cavity. The result is therefore identical to that which would be obtained with a very long cavity. Using a cavity a few centimeters in length has a certain advantage compared with a long cavity, since it makes it possible to avoid complex spectral filtering. A high-Q cavity is a cavity in which the mirrors have a reflection coefficient of greater than 80%.

In the following examples, the cavity is linear.

An example of a low-noise laser with a high-Q cavity will be described. The semiconductor used is a semi-VCSEL. It will be recalled that a VCSEL (Vertical Cavity Surface-Emitting Laser) is a laser emitting via the surface whose semiconductor active medium is vertical and surrounded on either side by a Bragg grating. A semi-VCSEL is a VCSEL in which the output face does not have a Bragg grating. The laser oscillation is then obtained by placing an output mirror in the external cavity. The output mirror may be a concave mirror or a plane mirror combined with a collimating lens. A cavity length of a few centimeters is then sufficient to obtain a Class A laser and consequently a laser of intrinsically low noise over a large spectral width. The semi-VCSEL, which acts here as amplifying medium, may be either optically pumped or electrically pumped.

A spectral filtering device, such as a Bragg grating and/or a Fabry-Perot interferometer, may furthermore be included in the cavity.

In a variant of a high-Q cavity laser, the cavity is linked back on itself by means of a photorefractive crystal. The photorefractive crystal makes it possible simultaneously to increase the photon lifetime and to carry out spectral filtering.

In another approach, based on a reduction in the population inversion lifetime in the active medium, a semiconductor is used for which the population inversion lifetime in the active medium is very short. The use of such an active medium allows the length of the laser cavity to be reduced to a few centimeters, or even a few millimeters. Active media that meet this criterion are quantum dot semiconductors or quantum cascade semiconductors. Furthermore, these active media make it possible to cover wavelengths ranging from the infrared range (quantum dots) to the THz (quantum cascade).

The approach based on reducing the population inversion lifetime in the active medium can of course be combined with the approach based on increasing the lifetime of the photons in the laser cavity.

Examples of this embodiment based on reducing the population inversion lifetime in the active medium and/or on increasing the lifetime of the photons in the laser cavity will now be described in relation to FIG. 3.

In the example shown in FIG. 3a, the laser includes an external cavity, that is to say one that extends beyond the semiconductor 2. The first face 21 of the semiconductor 2 acts as the first mirror of the laser cavity 14. The second face 22 itself has an antireflection treatment. A mirror 9 placed a few centimeters from the active medium 2 closes the laser cavity 14. The output mirror 9 may be a concave mirror (FIG. 3a) or a plane mirror combined with a collimating lens 11 (FIG. 3b) or a photorefractive crystal 12 combined with a collimating lens 11 (FIG. 3c). A face 13 of the photorefractive crystal acts as second mirror of the cavity. It should be noted that in the case of a THz laser, the extended cavity includes, in addition to the mirror 9, a THz waveguide 10, as shown schematically in FIG. 3d.

According to another example shown in FIG. 3e, the laser is monolithic and the means for obtaining τₚ>τ_{c} are based on the Q-factor of the cavity and on the choice of the active medium 2, which is for example a quantum cascade laser. To do this, reflective coating is deposited on the two faces 21, 22 of the active medium 2. Thus, the combination of the Q-factor, which increases the lifetime of the photons in the cavity 14, and of the short lifetime of the carriers, characteristic of the active medium chosen, results in class A operation of the laser. The length of the active medium (of the order of 1 mm) may be optimized so as to reduce the line width of the laser. The latter architecture has the advantage of being monolithic, and therefore easy to implement and less sensitive to external perturbations.

In these linear-cavity examples, the semiconductor is for example a quantum dot laser or a quantum cascade laser or a semi-VCSEL. The reflection coefficients of the mirrors of the cavity are preferably greater than 80%.

These examples may benefit, if necessary, from spectral filtering directly in the active medium (for example DFB-type filtering) or else in the cavity in the case of the external-cavity architecture.

1. A laser comprising a semiconductor active medium with a population inversion lifetime τ_{c} and a resonant cavity with a lifetime of the photons in the cavity τₚ, wherein the cavity is an external cavity and/or includes mirrors having a reflection coefficient R>80%, in order to increase τₚ so as to obtain τₚ>τₚ, and wherein the cavity includes means for being longitudinally monomode.

2. The laser as claimed in claim 1, wherein when the cavity is capable of producing several modes, the means for obtaining a monomode cavity include means for filtering these modes.

3. The laser as claimed in claim 1, wherein when the semiconductor has a length l, the cavity is external and has a length L>100 l so as to obtain τₚ>τ_{c}.

4. The laser as claimed in claim 1 wherein the means for filtering these modes comprise a Bragg grating and/or a Fabry-Perot interferometer.

5. The laser as claimed in claim 4, wherein the cavity includes an isolator and/or an optical fiber.

6. The laser as claimed in claim 1, wherein when the cavity is external and includes filtering means and at least one mirror external to the semiconductor, and the filtering means comprise said mirror is a photorefractive crystal.

7. The laser as claimed in claim 1, wherein when the cavity is external and includes an external output mirror, wherein the external output mirror is a concave mirror or a plane mirror associated with a collimating lens or comprises at least one photorefractive crystal.

8. The laser as claimed in claim 1, wherein the laser is monolithic and has two faces having a reflection coefficient R>80%.

9. The laser as claimed in wherein the semiconductor is one of a semi-VCSEL or quantum dot semiconductor or a quantum cascade semiconductor.

10. The laser as claimed in claim 1, wherein the semiconductor is a quantum cascade semiconductor and in that the cavity is external and includes a waveguide external to the semiconductor.

11. The laser as claimed in claim 1, wherein it further includes a feedback control device.

12. The laser as claimed in claim 1, wherein the cavity is a linear cavity.

13. The laser as claimed in claim 1, wherein the cavity is a ring cavity.

14 A laser comprising a semiconductor active medium with a population inversion lifetime τ_{c} and a resonant cavity with a lifetime of the photons in the cavity τₚ, wherein the cavity is an external cavity and/or includes mirrors having a reflection coefficient R>80%, in order to increase τₚ so as to obtain τₚ>τₚ, and wherein the cavity includes a Bragg grating and/or a Fabry-Perot interferometer.
